(19) United States
(12) Patent Application Publication
(10) Pub. No.: US 2010/0131200 A1
(43) Pub. Date: May 27, 2010

(54) GUIDING POSITIONING METHOD, POSITIONING DEVICE AND COMPUTER PROGRAM PRODUCT

(75) Inventor: Hannu Lohi, Kello (FI)

Correspondence Address: VOLPE AND KOENIG, P.C., UNITED PLAZA, SUITE 1600, 30 SOUTH 17TH STREET, PHILADELPHIA, PA, 19103, US

(73) Assignee: TRACKER OY, Oulunsalo (FI)

(21) Appl. No.: 12/594,603

(22) PCT Filed: Apr. 18, 2008
(86) PCT No.: PCT/FI2008/050201

§ 371 Date: Dec. 24, 2009

(30) Foreign Application Priority Data
Apr. 24, 2007 (FI) 20075283

(51) Int. Cl. G01C 21/00; G01S 19/42

(52) U.S. Cl. 701/213

(57) ABSTRACT

A method in which location information and bearing of the user of a positioning device are determined based on signals sent by positioning satellites. The user is instructed to act in a suitable way when the bearing is being determined. The method further determines a confidence parameter that indicates the reliability of the communicated bearing and is communicated to the user simultaneously with the bearing. The confidence parameter enables the user to estimate whether or not the communicated bearing information can be trusted. The confidence parameter can be determined from the number of positioning satellites connected to the satellite receiver and the determined traveling speed of the user of the positioning device, or from the dilution of precision provided by the GPS system. The confidence parameter gets a value “good”, when an equation is true, and a value “bad”, when the equation is false.

### FIELD OF THE INVENTION

The present invention relates to a guiding positioning method in which method with a positioning device, that includes a satellite receiver, positioning signals from several positioning satellites are received, a bearing of the user of the positioning device is determined using the received positioning signals, and the determined bearing is communicated to the user of the positioning device. The subject matter of the invention also includes a positioning device and a computer program product for loading a software program into the memory of the positioning device in order to implement the method according to the present invention.

### BACKGROUND

Presently, there are several different known electronic positioning methods and devices for determining the location of an object without utilizing a compass. These methods include, for example, the GPS (Global Positioning System) and Galileo positioning methods, which are based on satellite positioning; the location information systems used in WLAN or Zigbee radio networks; and the positioning systems based on cellular phone base station networks. The devices used in the methods are compact and portable positioning devices that include a display for presenting the positioning information. In addition to the actual location information, the positioning device can also display the bearing of a moving person in relation to compass points. Accurate evaluation of the bearing is an essential feature of a positioning device, because it enables the positioning device to be used as a guide for travelling from one place to another.

A disadvantage of the known positioning devices is that the determined bearing, especially for slowly moving objects, such as people on foot, is often imprecise and erroneous. The errors generated when determining the bearing are caused by the positioning error included in the positioning methods. In order to reliably determine a bearing, the user should understand that he/she should move far enough to make the directional effect generated by the movement significantly larger than the positioning error included in the positioning methods. However, especially when using satellite positioning methods, the user's movement hinders satellite reception and the reading of ephemeris and almanac, and thus hinders satellite timing. This in turn increases the possibility of generating positioning errors.

From the point of view of a user of a positioning device, it is problematic that he/she generally does not know how reliable the position information is that was determined and communicated to the user by the positioning device. Consequently, the user often blindly trusts the potentially faulty information provided by the positioning device. The above-described problem is especially highlighted in situations where the display of the positioning device does not show a map of the environment in the background, but only shows a direction arrow indicating the person's bearing. In such a case, the user cannot verify his/her bearing from the landmarks displayed on the map.

WO 02/086442 describes a positioning system that comprises a target unit and a locating unit, which both include a GPS receiver. The target unit determines its position based on the GPS signal and sends the position information to the locating unit. The locating unit determines its own position based on GPS signals, and uses its processor to compute a bearing and range to the target unit. The method can further include computing a confidence index for the defined bearing from the signal that comprises the position information and was communicated by the target unit. A signal comprising the position information and originating from the positioning target is thus always needed for the confidence index computation. If no signal is received from the positioning target, no confidence index can be calculated.

### SUMMARY

An object of the present invention is to bring forth an improved guiding positioning method, a positioning device, and a computer program product which can be used to reduce the drawbacks and faults of known positioning methods. The objects of the present invention are achieved with a positioning method, a positioning device, and a computer program product characterized in the independent claims. In the dependent claims, some preferred embodiments of the invention are described.

The subject matter of the present invention is a positioning method, in which positioning information is determined based on signals sent from positioning satellites. The method uses a positioning device that is equipped with a satellite receiver, which can receive positioning signals from several positioning satellites and can determine the location of the user based on the signals. In addition to the location, the method determines the bearing of the user of the positioning device, and communicates the determined bearing to the user of the positioning device. The basic idea behind the method according to the present invention is that the method further includes determining a confidence parameter that is communicated to the user of the positioning device. The confidence parameter is preferably communicated to the user of the positioning device simultaneously with the bearing. The confidence parameter informs the user of the positioning device about the reliability of the bearing, so that the user can judge whether or not the communicated information about the bearing can be trusted.

In the present invention, positioning signals are received from several positioning satellites, and the bearing is determined based on these positioning signals. Consequently, a positioning signal from a positioning target is not needed in the invention; rather, the confidence parameter computation only involves the positioning signals associated with the positioning device's user's own position finding and movement and information calculated based on these signals.

A preferred embodiment of the method according to the present invention determines the number of positioning satellites connected to the satellite receiver and the travelling speed of the user of the positioning device, and based on this information, determines the confidence parameter of the positioning signal. The confidence parameter is preferably determined using the equation:

v·(nmb−2)≧9, (1)

where

v=determined travelling speed of the user, km/h

nmb=number of satellites connected to the satellite receiver,

whereby the confidence parameter gets a value “good” when equation (1) is true, and a value “bad” when equation (1) is false.

Another preferred embodiment of the method according to the present invention first ascertains satellite reception. The user of the positioning device is preferably asked to stop moving if satellite reception cannot be ascertained otherwise.

The positioning device according to the present invention comprises an electronic terminal that includes a display, a memory, a processor, a satellite receiver for receiving positioning signals, and means for determining the bearing of the user of the positioning device. The positioning device further comprises means for determining the confidence parameter, which represents the reliability of the determined bearing, using the received positioning signals, and for communicating the confidence parameter to the user simultaneously with the bearing. The display of the terminal preferably includes a data field for communicating the confidence parameter value to the user using text, symbols and/or colours.

The method according to the present invention can be implemented with a software program that is loaded into the memory of the electronic terminal. The software program can be stored on storage means, such as a disc or a memory card, as a separate computer program product, and from there it can be loaded into the memory of the terminal. This computer program product comprises computer program means, stored on computer readable medium, for determining the bearing of the user using positioning signals sent from positioning satellites and for communicating the bearing to the user of the positioning device, and further, computer program means for determining a confidence parameter, which represents the reliability of the determined bearing, using the received positioning signals, and means for communicating the confidence parameter to the user of the positioning device. The said computer program means are preferably configured to communicate the confidence parameter to the user of the positioning device simultaneously with the bearing.

An advantage of the invention is that it improves the reliability of satellite positioning devices by reducing errors and inaccuracies associated with the bearing. The usability of positioning devices is thus improved.

A further advantage of the invention is that its implementation is simple and reliable.

### BRIEF DESCRIPTION OF THE DRAWINGS

In the following, the invention will be described in detail. The description references accompanying drawings, in which:

FIG. 1 shows, as an example, the different steps of the method according to the present invention as a simple flow chart.

FIGS. 2a-2e show, as an example, a positioning device according to the present invention, and a front view of its display.

### DETAILED DESCRIPTION OF THE PREFERRED EMBODIMENTS

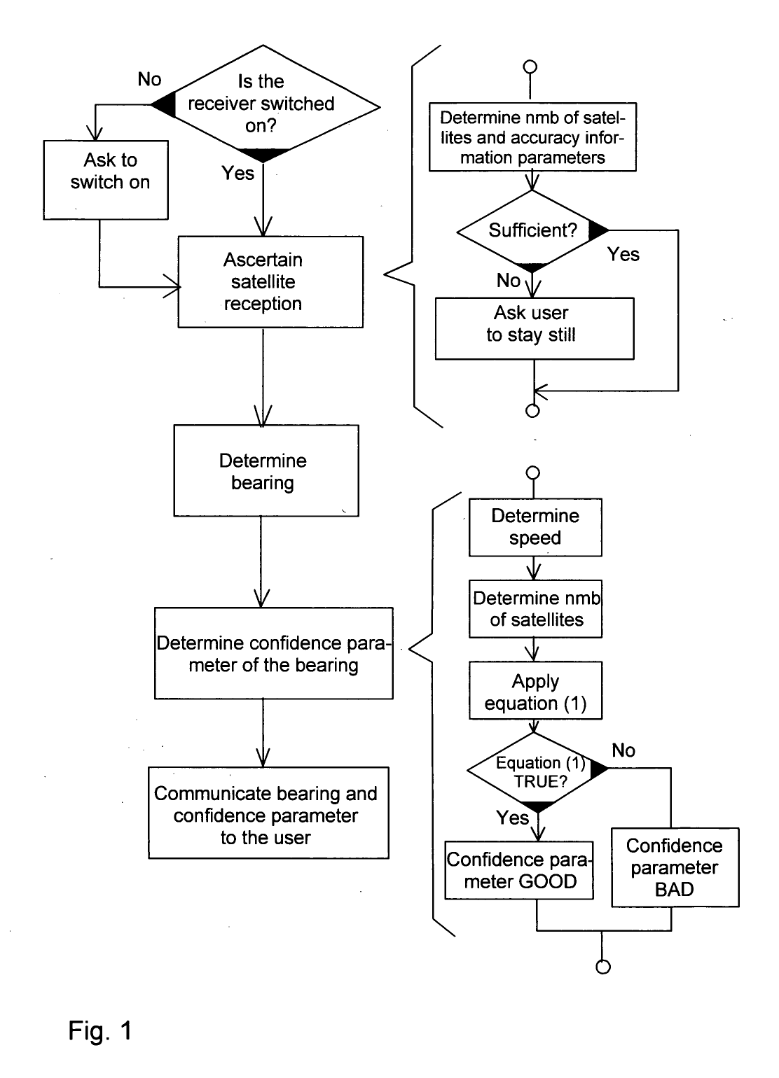

FIG. 1 shows, as an example, the different steps of the method according to the present invention as a flow chart.

The invention can be used along with positioning methods in which a positioning device used by a user determines its position based on signals sent by positioning satellites. These kinds of commercial satellite positioning methods include, for example, the GPS positioning system currently in use and the Galileo positioning method that is to be introduced in the future. Sending positioning signals from a satellite and processing them on a positioning device, as related to satellite positioning, is a known technique per se, so it will not be described further in this text. There are several structurally different satellite positioning devices on the market. The technical parts required for positioning can either be included in a single device, or the positioning device can include a satellite receiver that receives a positioning signal and a terminal, such as a mobile phone, that is connected to the satellite receiver with a data transmission connection and has a software program loaded into its memory, which software program is used for processing the positioning signals and, based on them, determining a location. The invention is not limited to a particular positioning device; rather, it can be used with all satellite positioning methods and devices.

The method according to the present invention operates when the positioning device is functional, i.e. it is in a state in which it receives positioning signals sent by positioning satellites. Therefore, the method first checks whether the satellite receiver is switched on. If the satellite receiver is not switched on, the user is asked to switch it on. After it has been switched on, the satellite receiver instantly starts to receive positioning signals from those positioning satellites that are “visible” and to which a connection can be formed in order to receive a signal. The number of connected satellites and the accuracy parameters of the received positioning signals are affected, inter alia, by the location and movement of the user of the positioning device. In a forest for example, where there are large altitude differences and the trees grow close to each other, the number of connected satellites is often low and the accuracy information parameters are weak. On the other hand, in level, open terrain, the number of connected satellites is high and the accuracy information parameters are good.

When determining the bearing of a user, satellite reception is first ascertained. Good reception is a prerequisite for satellite position finding. Ascertaining satellite reception includes checking that the number of satellites connected to the satellite receiver is large enough and that the quality of the accuracy information parameters of the receiver of the positioning device is good enough for determining a location. If it is determined that the number of connected satellites is not sufficient or that the accuracy information parameters are not good enough, the user is asked to stay still. Staying still facilitates establishing a connection from the satellite receiver to the satellites. It has been observed that satellite reception is ascertained well enough at least then when the satellite receiver is connected to seven satellites.

After satellite reception has been ascertained, the user is instructed to move, so that bearing and speed can be determined. Bearing and speed are determined in the satellite positioning device using known techniques which shall not be described here in detail. Bearing is determined based on determining a direction between two points located on the user's route. The direction information can be further determined using methods based on the Doppler effect, for example. Bearing is usually communicated to the user with a direction arrow displayed on the screen of the positioning device, and speed is communicated with a numerical value displayed on the screen. In the method according to the present invention, a confidence parameter of the bearing is also determined for the determined bearing. The confidence parameter is communicated to the user along with the bearing. The determined confidence parameter can get a value “good” or a value “bad”. A value “good” means that the user can trust the bearing that was determined with the method and communicated to the user. A confidence parameter value “bad”, on the other hand, means that the bearing determined with the method might be imprecise or erroneous, whereby the user knows to take the communicated bearing information with reserve. In order to determine the confidence parameter, the method first determines speed v of the user of the positioning device and the number of satellites connected to the satellite receiver of the positioning device. This information is determined using a known technique commonly used with satellite positioning devices, which shall not be described further here. The confidence parameter is then determined with the experimentally derived equation (1).

v·(nmb−2)≧9, (1)

where

v=determined travelling speed of the user, km/h

nmb=number of satellites connected to the satellite receiver.

It has been observed, that if equation (1) is true, then the bearing has been reliably determined. The confidence parameter of the bearing thus gets a value “good”. On the other hand, if equation (1) is false, the bearing is not sufficiently reliable and the confidence parameter gets a value “bad”. Using equation (1), it can be calculated that when the satellite receiver is connected to 12 satellites, the travelling speed of the user should be at least 0.9 km/h in order to get a good confidence parameter value. Similarly, if the satellite receiver is connected to 4 satellites, the travelling speed of the user should be at least 4.5 km/h in order to get a good confidence parameter value. If the user's speed is below these threshold values, the confidence parameter gets a value “bad”. Naturally, the travelling speed and the number of connected satellites can change as the user moves, which can affect the confidence parameter value. In the method according to the present invention, the confidence parameter is continuously determined at suitable intervals whenever the device is on, and the confidence parameter that is communicated to the user is always the latest determined value.

Equation (1) is only one preferred way for estimating the confidence parameter that has been found to be functional. The method according to the invention is not limited to the mode implemented with equation (1), and other computational modes are also possible. One possible way of determining the accuracy parameter uses a dilution of precision (DOP) that the GPS system's positioning devices automatically determine when determining a position. The DOP reports the “margin of error” included in the position information communicated by the positioning device. The confidence parameter can be determined, for example, by defining threshold values of the DOP, values over or under which threshold values will earn a certain value of the confidence parameter. Also, the confidence parameter can have more than two values when it is determined from a DOP. Consequently, other “intermediary values” describing the reliability of the bearing can be defined for the confidence parameter in addition to “good” and “bad”.

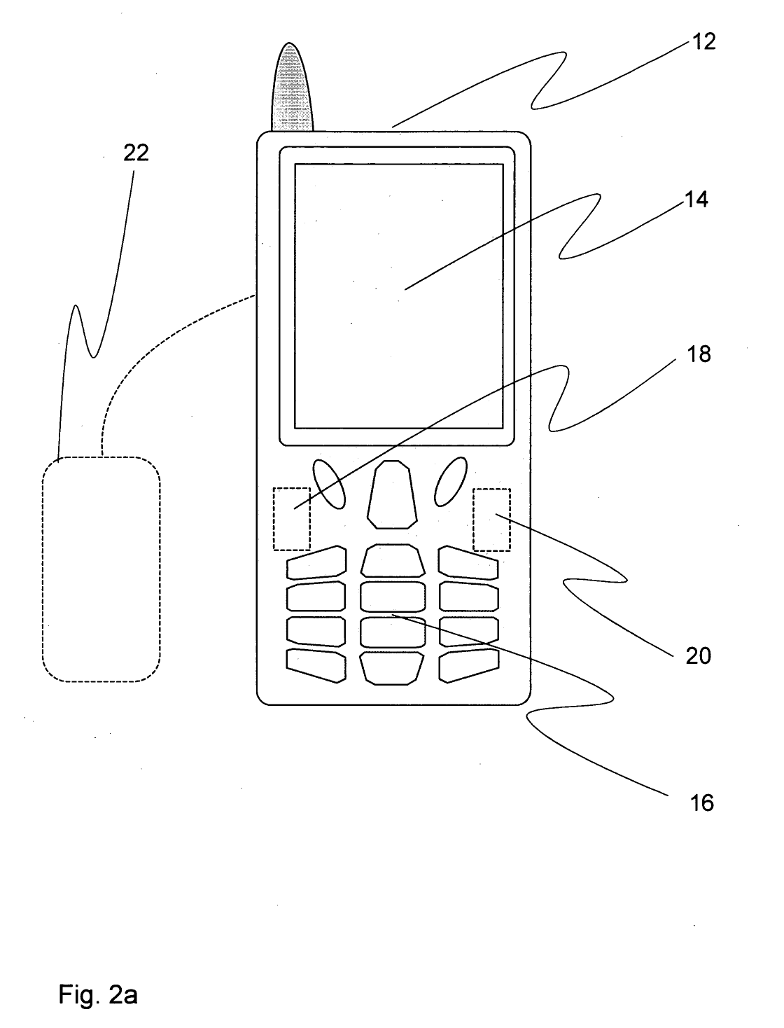

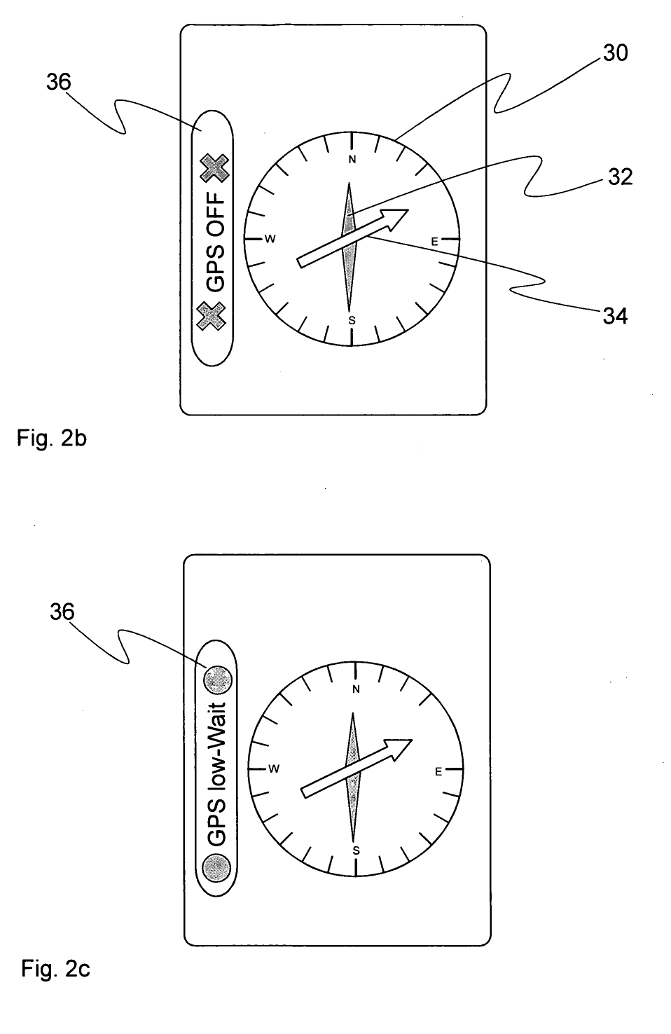

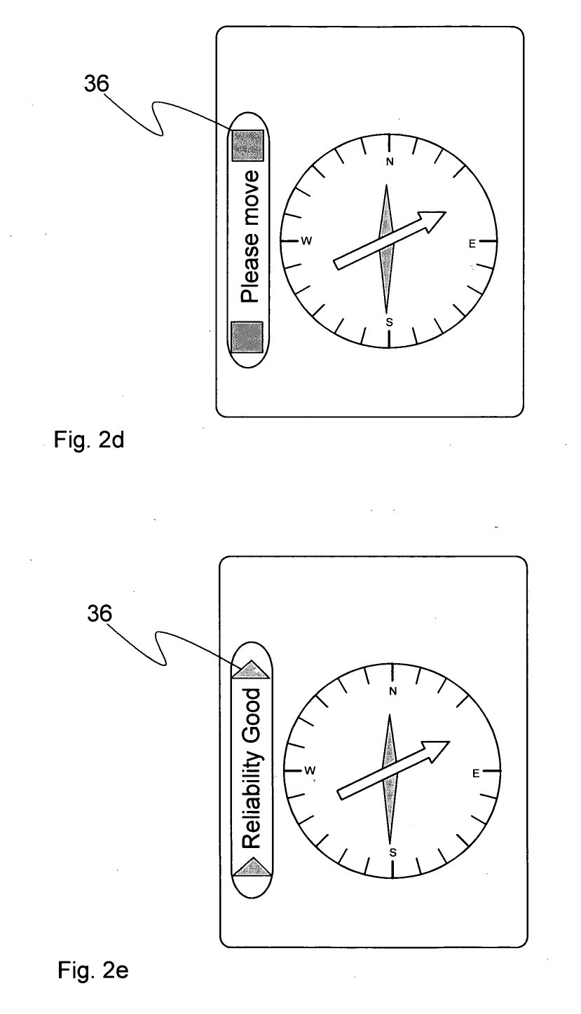

FIG. 2a shows, as an example, the satellite positioning device according to the present invention that uses the improved positioning method according to the present invention. The positioning device comprises an electronic terminal 12 that includes a display 14 for outputting information and a keyboard 16 for inputting information. The terminal includes a memory 18 for storing information, such as software programs, and a processor 20 for executing software programs. The positioning device further includes a satellite receiver 22 for receiving positioning signals sent by positioning satellites. The satellite receiver can be an integral part of the positioning device, or it can be a separate device that is connected to the terminal 12 with a data transmission connection. The terminal is preferably a mobile phone with a software program loaded into its memory, the software program can determine the position information from positioning signals received via the satellite receiver.

The above-described method according to the present invention can be implemented with a software program that is loaded into the memory of the terminal. The software program can be stored on the storage medium as a separate computer program product that can be loaded into the memory of the terminal from the storage media. The software program can also be loaded into the terminal via a wired or wireless data transmission network, such as a GPRS, UMTS or WLAN network. The processor of the terminal executes the operations defined in the software program, which implement the steps of the method according to the present invention. With the software program, a direction arrow depicting the bearing of the user and, simultaneously, the current determined value of the confidence parameter can be generated to the display of the terminal.

FIGS. 2b-2e show, as an example, details of the display 14 of the electronic terminal when the processor 20 of the terminal executes operations defined in the software program that is loaded into the memory of the terminal. In the centre of the display, a compass ring 30 is displayed, that includes a northward arrow 32 and a direction arrow 34 that depicts the user's bearing. The left side of the display includes a data field 36, which displays icons and text that communicate instructions and information to the user. The top and bottom parts of the display and the edges of the compass ring can further include other data fields, which can display various pieces of information associated with positioning targets and movements of the user. However, these are not within the scope of the present invention, so they will not be described further here.

In FIG. 2b, the positioning device is in a switched off state. The data field now shows an icon representing the switched off state of the device and the text “GPS OFF”. In FIG. 2c, the positioning device is in a switched on state, but the number of connected satellites is too low or the positioning signal is too weak so that satellite reception cannot be ascertained. Data field 36 now shows an icon representing this state simultaneously with the text “GPS low—Wait”. FIG. 2d shows the display of the positioning device in a state where satellite reception has been ascertained and the user is being asked to move in order to determine the bearing. The data field shows an icon representing the state simultaneously with a move request text “Please move”. In FIG. 2e, the user of the positioning device is moving and the direction of the movement in relation to the compass is shown on the display with the direction arrow 34. The data field 36 displays the text “Reliability Good”, informing the user that the confidence parameter gets a value “good”, which means that he/she can trust the information communicated with the direction arrow. If the confidence parameter switches to a value “bad”, the data field text is also switched to read “Reliability Poor”. The display states shown in FIGS. 2b-2e are provided only as examples. It is clear that the same information and instructions can be provided to the user of the positioning device with other kinds of icons and pieces of text, or just with different symbols and/or colours.

In the preferred embodiment of the present invention shown in FIGS. 2b-2e, the confidence parameter is communicated to the user by generating text into a data field which clearly states the confidence parameter value. The confidence parameter can also be communicated in some other manner in addition to the one described above. In a preferred embodiment of the present invention, the confidence parameter is communicated to the user only when the confidence parameter gets a value “good”. This is done by generating a text “Heading OK” into the data field. If the confidence parameter gets a value “bad”, the parameter will not be specifically communicated to the user. In another preferred embodiment of the present invention, the direction arrow representing the bearing is generated to the display of the positioning device only if the confidence parameter gets a value “good”. If the confidence parameter gets a value “bad”, the direction arrow will not be displayed on the screen of the positioning device.

In the preceding, certain preferred embodiments of the positioning method, the positioning device, and the computer program product according to the present invention have been described. The invention is not limited to the above-described solutions, and its inventive idea can be implemented in several different ways within the scope of the claims.

1. A guiding positioning method, in which with a positioning device, that includes a satellite receiver, a positioning signal from several positioning satellites is received, a bearing of the user of the positioning device is determined using the received positioning signals, and the defined bearing is communicated to the user of the positioning device, characterized in that in the method a confidence parameter representing the reliability of the bearing is determined based on the received positioning signals, which confidence parameter is communicated to the user of the positioning device.

2. The method according to claim 1, characterized in that the confidence parameter is communicated to the user of the positioning device simultaneously with the bearing.

3. The method according to claim 1, characterized in that in the method the number of positioning satellites connected to the satellite receiver and the travelling speed of the user of the positioning device are determined, and the confidence parameter of the positioning signal is determined based on this information.

4. The method according to claim 3, characterized in that the confidence parameter is determined with the equation:
v·(nmb−2)≧9, (1)
where
v=determined travelling speed of the user, km/h
nmb=number of satellites connected to the satellite receiver,
whereby the confidence parameter gets a value “good” when equation (1) is true, and a value “bad” when equation (1) is false.

5. The method according to claim 1, characterized in that the positioning method is the GPS positioning method and the confidence parameter is determined using the dilution of precision defined in that method.

6. The method according to claim 1, characterized in that in the method satellite reception is first ascertained.

7. The method according to claim 6, characterized in that the user of the positioning device is asked to stop moving if the satellite reception is not sufficient.

8. A positioning device that comprises an electronic terminal, having a display, a memory, a processor, a satellite receiver for receiving positioning signals, and means for determining a bearing of the user of the positioning device, characterized in that the device further comprises means for determining, based on the received positioning signals, a confidence parameter that represents the reliability of the determined bearing, and for communicating the confidence parameter to the user.

9. The positioning device of claim 8, characterized in that the confidence parameter is arranged to be communicated to the user simultaneously with the bearing.

10. The positioning device according to claim 8, characterized in that the display of the terminal includes a data field for communicating the confidence parameter value to the user using text, symbols, and/or colours.

11. The positioning device according to claim 8, characterized in that the said means for determining the confidence parameter comprise a software program loaded in the memory of the terminal.

12. A computer program product that comprises computer program means, stored on computer readable medium, for determining a bearing of the user of a positioning device using positioning signals sent from positioning satellites, and for communicating the bearing to the user of the positioning device, characterized in that the computer program product further comprises computer program means for determining, based on the received positioning signals, a confidence parameter that represents the reliability of the determined bearing, and for communicating the confidence parameter to the user.

13. The computer program product of claim 12, characterized in that the said computer program means are configured to communicate the confidence parameter to the user simultaneously with the bearing.

14. The computer program product of claim 12, characterized in that the said computer program means are configured to determine the number of positioning satellites connected to the satellite receiver and the travelling speed of the user of the positioning device, and to determine the confidence parameter based on this information.

15. The computer program product of claim 14, characterized in that the said computer program means are configured to determine the confidence parameter using the following equation:
v·(nmb−2)≧9, (1)
where
v=determined travelling speed of the user, km/h
nmb=number of satellites connected to the satellite receiver,
whereby the confidence parameter gets a value “good” when equation (1) is true, and a value “bad” when equation (1) is false.

16. The computer program product of claim 12, characterized in that the said computer program means are configured to determine the confidence parameter using a dilution of precision determined in the GPS positioning method.

17. The computer program product of claim 12, characterized in that it further comprises computer program means for ascertaining satellite reception.

18. The computer program means of claim 17, characterized in that the said computer program means are configured to provide a stop request to the user if the satellite reception is not sufficient.
